(19) United States
(12) Patent Application Publication
(10) Pub. No.: US 2024/0004135 A1
(43) Pub. Date: Jan. 4, 2024

(54) RIBBON FIBER WINDOW STRIPPING AND HIGH DENSITY HERMATIC CEROCAST

(71) Applicant: ALLIANCE FIBER OPTIC PRODUCTS, INC., Sunnyvale, CA (US)

(72) Inventors: Xingzhong Wang, Fremont, CA (US); Qijun Xiao, Fremont, CA (US); Hao Zhang, San Jose, CA (US)

(21) Appl. No.: 18/368,305

(22) Filed: Sep. 14, 2023

Related U.S. Application Data
(63) Continuation of application No. PCT/US22/19422, filed on Mar. 9, 2022.

(51) Int. Cl. G02B 6/245

(52) U.S. Cl. CPC G02B 6/245

(57) ABSTRACT

A method for window stripping ribbonized optical fibers is provided including applying a tensile force to the ribbonized optical fibers, applying heated air flow to the ribbonized optical fibers, such that a coating of the ribbonized optical fibers softens or detaches from the optical fibers, and stripping the coating from the optical fibers using at plurality of blades, which do not contact the optical fibers.

### PRIORITY APPLICATION

This application is a continuation of International Patent Application No. PCT/US2022/019422 filed on Mar. 9, 2022, which claims the benefit of priority of U.S. Provisional Application No. 63/163,155, filed on Mar. 19, 2021, the content of which is relied upon and incorporated herein by reference in its entirety.

### FIELD OF THE DISCLOSURE

The technology of the disclosure relates to stripping of fiber optic cables. More particularly, the disclosure relates to window stripping of optical fiber ribbons.

### BACKGROUND

Glass optical fibers have very small diameters and are susceptible to external influences such as mechanical stress and environmental conditions. To protect the optical fiber from such influences, each optical fiber or optical fiber ribbon is provided with one or more coatings of a of protective material. For hermetic sealing of fiber optic products, a portion of the coating must be removed from specific position and length (e.g. window stripping).

Optical fibers may be subjected to one or more forms of impairment when their polymer coatings are removed or stripped. Standard methods for removing an optical fiber's polymer coating include mechanical stripping, acid stripping, laser stripping, plasma stripping, and hot gas stripping. Mechanical stripping involves using a stripping tool to remove the polymer coating from the optical fiber. The stripping tool cuts through the polymer coating, and in some instances may cause scratches on the optical fiber, which may in turn causing degradation to tensile strength of the optical fiber.

Another method of removing an optical fiber's polymer coating with minimal degradation includes acid stripping using a hot sulfuric nitric mixture. Although tensile strength degradation is minimized in acid stripping, chemicals may flow between the optical fibers and the polymer coating that remains on the optical fiber beyond the stripped region. Additionally, safety concerns are often present with acid stripping methods. Field technicians employing acid stripping methods require well-ventilated areas. However, such facilities are generally not readily available to the field technicians.

Coating may also be stripped from an optical fiber by plasma flow or laser beam, however, both have greater impacts on the optical fiber, which may reduce the tensile strength force. Additionally, plasma flow or laser beam stripping may utilize expensive equipment. Furthermore, coating residues may be a concern due to laser or plasm beam imposes high temperature and extensive reactions with the coating materials, generating hard layers sticking to bare optical fiber, which may be difficult to be removed.

It may also be difficult to remove the coating from an array of optical fibers such as a optical fiber ribbon since coating material is situated between closely spaced optical fibers.

### SUMMARY OF THE DETAILED DESCRIPTION

An example embodiment of this disclosure provides a method and apparatus for removing coating from a coated optical fiber or a coated array of fibers in specific window region. The method enables stripping coating from optical fibers in such a manner that the bare fiber surface is sufficiently clean and free from scratches or other mechanical damage.

Another embodiment of the disclosure provides a method and apparatus for stripping multiple optical fiber ribbons simultaneously. In high density hermetic applications, multiple optical fiber ribbon stripping, alignment and sealing are advantageous to reduce process time. Previous stripping methods may be difficult or impossible to reliably utilize for multiple optical fiber ribbons in one apparatus. Further, stripped optical fibers may be very delicate and difficult to align. In an embodiment stripping and alignment of all post aligned ribbons are enabled by a pre-alignment fixture simultaneously, therefore the process may easily add wet clean and ultrasonic pre-soldering process after stripping without further alignment of stripped optical fiber.

In a further embodiment, approaches of improving the effectiveness of hermetic sealing are provided. Glass optical fiber may have bad wettability with most of solder alloys and a traditional cerocast method may be limited to single fiber. Additionally, in high density applications, air gaps between optical fibers are difficult to remove. The method improves the wettability of the optical fiber by utilizing an ultrasonic pre-solder after fresh fiber stripping and cleaning. Further, the pressure of molten solder liquid inside sealing tube is maximized by an improved tube end sealing and clamping design, such that most or all air bubble and gap are squeezed out. The solder is bonded with optical fiber glass more reliably and the tested leak rated is reduced dramatically.

Additional features and advantages of the invention will be set forth in the detailed description which follows, and in part will be readily apparent to those skilled in the art from that description or recognized by practicing the invention as described herein, including the detailed description that follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operation of the invention.

### BRIEF DESCRIPTION OF THE FIGURES

While the specification concludes with claims particularly pointing out and distinctly claiming the subject matter of the written description, it is believed that the specification will be better understood from the following written description when taken in conjunction with the accompanying drawings, wherein:

FIG. 1 is flowchart and cross-sectional diagram of a stripping and sealing process according to one embodiment;

FIG. 2 is a cross-sectional diagram of thermo-mechanical stripping according to one embodiment;

FIG. 3 is a detail of the thermo-mechanical stripping process of FIG. 2;

FIG. 4 illustrate a schematic view of alignment of the optical fiber ribbons for window stripping according to one embodiment;

FIG. 5 illustrates an alignment apparatus for hermetic sealing according to one embodiment;

FIG. 6 shows a tensile strength test comparisons of single fibers using the disclosed process and hot plasma stripping according to one embodiment;

FIG. 7 illustrates the effectiveness of the disclosed hematic sealing process compared with traditional cerocast method according to one embodiment;

FIG. 8 illustrates a stripping jig according to an example embodiment;

FIG. 9 illustrates the stripping jig of FIG. 8 including a stripping assembly according to an example embodiment;

FIG. 10 illustrates the stripping jig of FIG. 8 including a optical fiber ribbon with stripped bare optical fiber according to an example embodiment;

FIG. 11 depicts the stripping jig of FIG. 8 including an ultrasonic pre-soldering assembly according to an example embodiment;

FIG. 12 depicts the hermetic sealing assembly according to an example embodiment;

FIG. 13 depicts a heating block according to an example embodiment;

FIG. 14 depicts an exploded view of a sealing block according to an example embodiment;

FIG. 15 depicts a bottom perspective view of an injection block according to an example embodiment; and

FIG. 16 illustrates injects of solder into the hermetic sealing tube and removable according to an example embodiment.

### DETAILED DESCRIPTION

Reference will now be made in detail to embodiments of the present invention, examples of which are illustrated in the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

In an example embodiment, a process for window stripping and sealing of optical fiber ribbon is provided. The method includes a hybrid coating removing system with mechanic blades, heated air, and wet cleaning of single or optical fiber ribbons. The system effectively strips single or optical fiber ribbons includes numerous advantages including, without limitation, minimum degradation of the optic fiber properties, especially the mechanic tensile strength; environmental safety, the coat material is heated below chemical reaction temperature; application to the multiple fiber ribbon window stripping and soldering after all the ribbons are aligned, avoiding fiber breaking or damage in high density fiber hermetic device manufacture; and low leak rate tested by utilizing ultrasonic soldering and high-pressure solder injection compared with normal cerocast hermetic sealing methods.

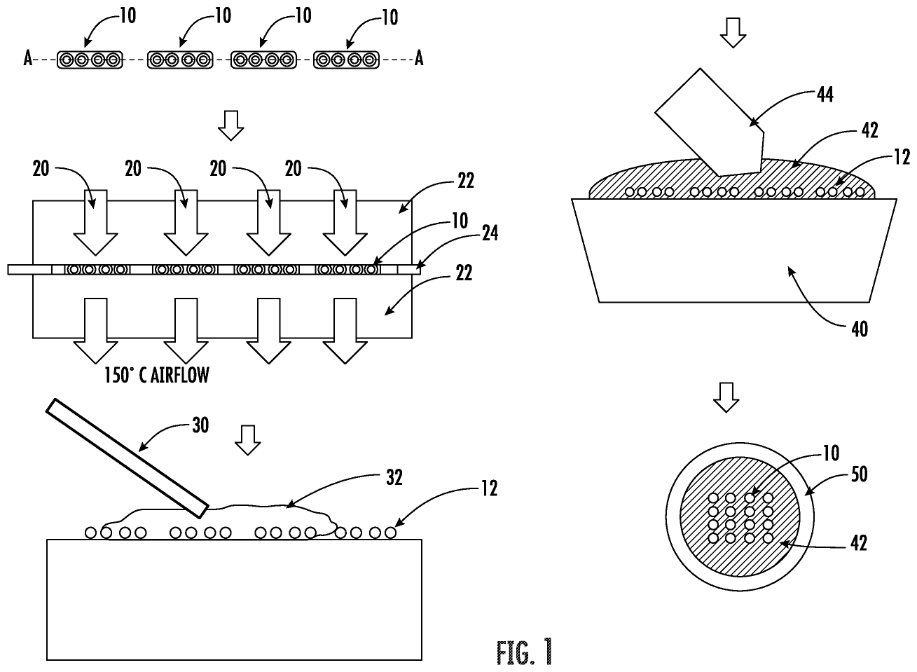

FIG. 1 shows a flow chart and processes of stripping and sealing of ribbonized optical fibers, e.g. a optical fiber ribbons. First, multiple optical fiber ribbons 10 are aligned along plane A, in apparatus to meet specific sequence and orientation requirements, as described below. A tensile force is applied to each fiber or optical fiber ribbon 10. For example, the tensile strength may be approximately 5 percent of the breaking force of the optical fiber, such as 10 kpsi. In an example embodiment, the sections of optical fiber ribbons 10 to be stripped are placed in a generally horizontal orientation for stripping, cleaning, and pre-soldering steps discussed below.

A heater air flow 20 is provided to the stripping area to cause the coating to just melt, for example 150 degree Celsius based on a single mode 125 um fiber with acrylic coating. 150 degrees Celsius is greater than the transition temperature, but lower than a temperature at which the coating may give off gases, e.g. approximately 200 degrees Celsius or above. Blades 22 cut into the coating of the optical fiber ribbons 10 to strip the coating from the optical fibers. However, the opposing blades 22 are prevented from contacting the optical fiber 12 by a gap control sheet 24, which includes a thickness that is greater than the diameter of the optical fiber 12.

Next, the method includes a wet cleaning step. An applicator 30 applies solvent 32 to the bare optical fibers 12. The solvent may be chosen for minimum damage to coating surrounding the bare optical fibers 12, such as acetone and/or isopropyl alcohol. In an example embodiment, acetone is used first to clean the bare optical fibers 12, then alcohol is used to complete the wet cleaning process and to remove acetone. Acetone may have superior cleaning properties for removal of the coating, but may impacts the surface of a substrate, such as anodized aluminum, and is therefore removed with alcohol.

Next, ultrasonic pre-soldering may be arranged directly on top of an ultrasonic transducer 40 for the highest energy transferring. The bare optical fibers 12 may be arranged on or near, e.g. within 1 mm, of the ultrasonic transducer 40. A solder 42 may be applied to the bare optical fibers 12 and heated by a heat source 44, such as one or more solder irons, to a temperature above the melting point of 138 degrees Celsius, such as 150-170 degrees Celsius. The solder 42 may be eutectic solder, such as Bismuth 58/Tin 42, or non-eutectic solder, such as Bismuth 40/tin 60, or other suitable solder. The ultrasonic pre-soldering may disrupt oxides that form on molten solder and base surfaces during the joining process.

The optical fiber ribbons 10 may be transitioned to a vertical orientation for soldering. A tensile force may be applied to the optical fiber ribbons 10. For example, the tensile strength may be approximately 5 percent of the breaking force of the optical fiber, such as 10 kpsi. The optical fiber ribbons 10 may then be sealed in a tube 50 filled with pressurized solder 42. The tube 50 may be a brass tube with a gold coating to limit or prevent oxidation of the tube 50. The dimensions of the tube 50 may be sufficient to protect the bare optical fibers 12 and a portion of the coated fibers, for example a length of 20 mm, outer diameter of 2.88 mm, and an inner diameter of 2.05 mm. The process of window stripping of optical fiber ribbons and hermetic sealing is discussed in further detail below.

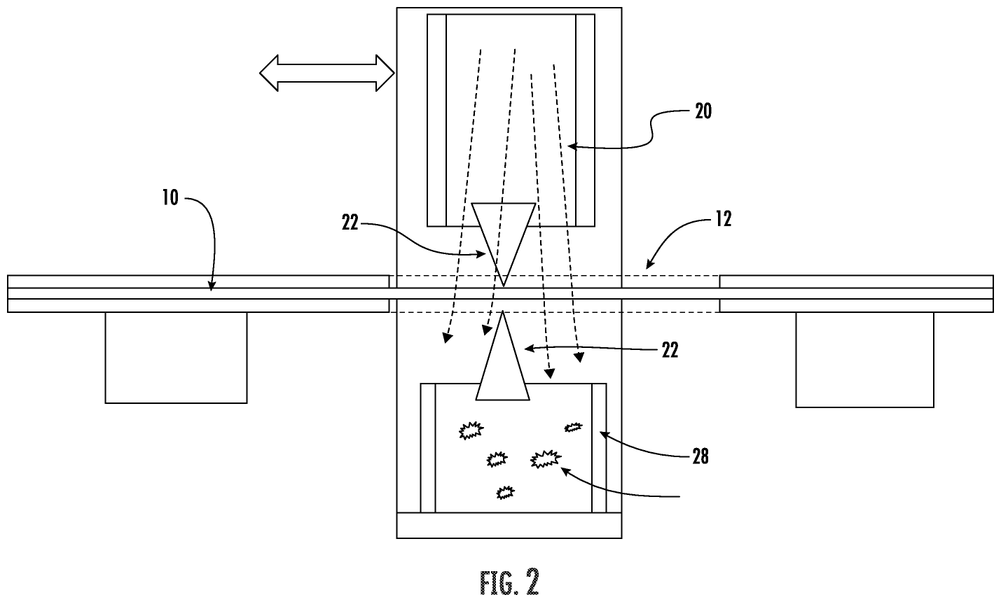

FIG. 2 is the diagram of themo-mechanic stripping, the region of the optical fiber or optical fiber ribbon 10 to be stripped is placed between two blades 22 whose gap distance in stripping process is larger than the diameter of bare optical fibers 12, but smaller than the thickness of coating of the optical fiber ribbons 10. The blades 22 and the portion of the optical fiber ribbon 10 to be stripped is heated by external air flow 20. When the polymer coating temperature reaches a melting point, for example 150C for acrylate coating, the coating turns soft and detaches partially from the optical fibers. The blades cut into, and crushes the coating into debris particles 26, as the blades 22 are moved horizontally along the optical fiber, the coating is further crushed and peeled off of the optical fibers with the heated air flow 20. This combined method solves problems in previous methods that rely on single type of process, the blades 22 do not cut all the way through the coating, and therefore cannot mare the surface of the optical fiber. The heating temperature is below the chemical reaction point of coating materials, therefore limiting or preventing the adhesion of the coating to the optical fiber during the stripping process. In some embodiments, the process includes a vacuum line disposed opposite to the heated air flow 20. The vacuum line 28 may capture dust, debris, and/or coating pieces from the stripping process and may also aid in the peeling of the coating from the bare optical fiber 12.

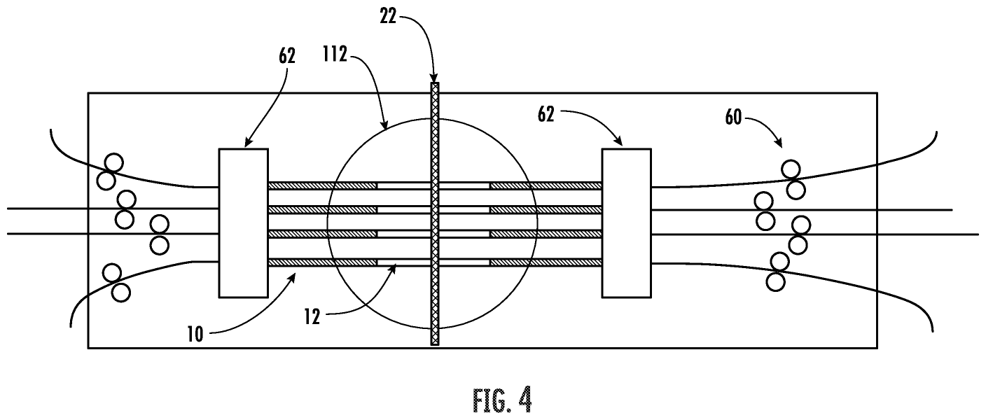

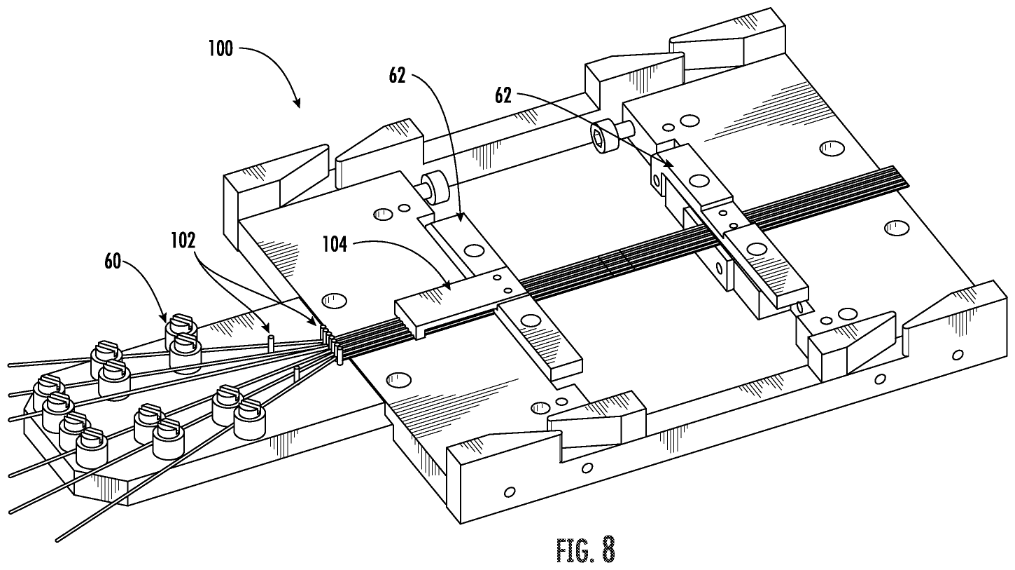

Turning to FIG. 8, a stripping jig 100 may be provided to enable precision alignment and orientation of the optical fiber or optical fiber ribbon 10. The optical fiber ribbons 10 may be fed through a plurality of tensioners 60. Each of the tensioners 60 may include, for example, two opposing D-shape wheels with rubber covering configured to grip the outer portion of the coating of the optical fiber ribbons 10. The described tensioners 60 are merely for illustrative purposes and other tensioner systems or apparatuses may be used. A second set of tensioners 60 may be disposed on the opposite end of the stripping jig 100, as indicated in FIG. 4. The optical fiber ribbons 10 may then be routed through a plurality of vertically oriented orientation posts 102. The orientation posts 102 may be configured to guide the optical fiber ribbons 10 from a fanned out configuration extending from the tensioners into the stripping jig 100 at a predetermined parallel spacing larger than a width of the optical fiber ribbon, such as 5 mm. The optical fiber ribbons 10 may then engage an orientation block 104. The orientation block 104 may apply pressure to the optical fiber ribbons 10 at an approximately 45 degree angle, staring an orientation shift from a vertical stacked configuration to a horizontal plane configuration. The orientation shift may be completed by clamps 62. The clamps 62 may retain the optical fiber ribbons 10 in the horizontal plane orientation and limit or prevent movement axially or radially. Additionally, the clamps 62 may align the optical fiber ribbon 10 vertically with respect to the blades 22. In an example embodiment, the clamps 62 may rotate into and out of engagement with the optical fiber ribbons 10 about a hinge or pin. In some example embodiments the orientation block 104 may be connected to or integral to one or the clamps 62 and rotate with the clamp. The rotational engagement of the orientation block 104 and/or the clamps 62 with the ribbon fiber 10 may be configured to dissipate the rotational torque applied to the optical fiber ribbon 10 along a length of the optical fiber ribbon, thus reducing stress applied to the optical fiber ribbon 10 during the stripping process.

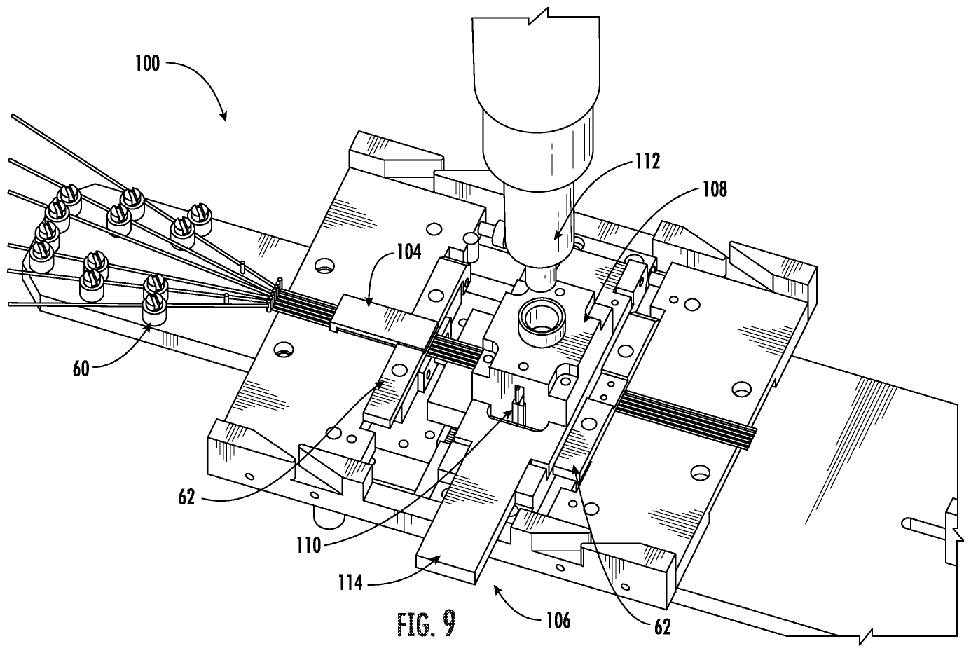

FIG. 9 depicts the stripping jig 100 including a stripping assembly 106. The stripping assembly may comprise one or more subassemblies, such as an air shroud 108, a blade assembly 110, and a shuttle 114. The shuttle 114 may be disposed between the stripping jig 100 and the optical fiber ribbon 10. The shuttle may be configured to translate along the optical fiber ribbon 10 within the stripping jig 100. For example, the shuttle 114 may be configured to slide on a surface of the stripping jig 100, or may engage one or more bearings, wheel, rails, or the like to enable smooth translation of the shuttle 114 within a predetermined vertical offset from the optical fiber ribbon 10. The shuttle 114 may be translated manually, by a technician, or may be translated by automation, such as by one or more worm gears, piston actuators, or the like.

The air shroud 108 may be configured to receive and direct heated air flow 20 from a heat source 112. The air shroud 108 may include an air inlet configured to engage a nozzle of the heat source 112. The air shroud 108 may cause the heated air flow 20 to surround the optical fiber ribbon 10 at the stripping area and limit or prevent heating of the optical fiber ribbon 10 in other areas.

The air shroud 108 and/or the shuttle 114 may include the blade assembly 110. The blade assembly 110 may include one or more upper blades and one or more lower blades. In the depicted embodiment, the shuttle 114 includes lower blades disposed opposite upper blades affixed to the air shroud 108. The air shroud 108 may be hingedly mounted to the shuttle 114, such that when the air shroud 108 is transitioned to a closed position the optical fiber ribbon 10 is disposed between the blades 22 of the lower blades of the shuttle 114 and the upper blades of the air shroud 108. The blade assembly 110 may also include a gap control sheet 24 disposed between the plurality of blades, as depicted in FIG. 1. The gap control sheet 24 may have a thickness that is greater than the diameter of the optical fibers. The gap control sheet 24 may be configured to obstruct movement of the blades 22 toward the optical fibers, such that the blades 22 engage with the coating of the optical fiber ribbons 10, but are prevented from contacting the optical fibers. In one example embodiment, the optical fibers may have a diameter of 125 um with a 250 um diameter coating. The gap control sheet 24 may have a thickness of 140-160 um.

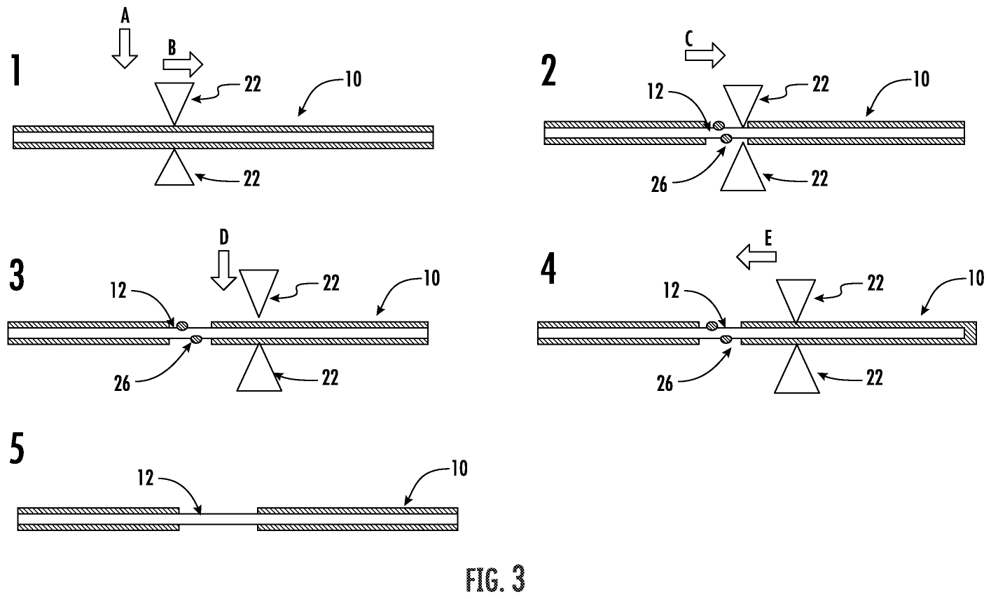

FIG. 3 is a detail of steps of thermo stripping process. In the depicted embodiment, the blades 22 move back and forth, from Detail 1-5, so that coating and/or debris 26 can be removed the optical fibers assisted by heated airflow. Initially at Detail 1, the blades 22 advance toward the optical fiber ribbon 10 cutting at least a portion of the coating around the optical fiber, as indicated by arrow A. The blades 22 may then be moved to the left or right, as shown here and indicated by arrow B. The movement of the blades 22 relative to the optical fiber ribbon 10 may cause the coating to be removed from the optical fiber. In Detail 2, the blades 22 have moved to the right, as indicated by arrow C, removing the coating and exposing the bare optical fiber 12. The bare optical fiber 12 may have one or more coating pieces or debris 26, which may be removed by the heated air flow 20 during the stripping process, or may be removed during the wet cleaning step. At detail 3, the blades 22 have been withdrawn and repositioned to the right of the window stripped area, in which the bare optical fiber 12 is exposed. The blades 22 advance toward the optical fiber ribbon, as indicated by arrow D, cutting into a portion of the coating. The blades 22 may then move toward the window stripped area, as indicated by arrow E. As the blades move the coating of the optical fiber ribbon 10 may be removed to expose additional bare optical fiber 12. Finally, at Detail 5, the blades have been withdrawn and the optical fiber ribbon 10 includes a completed window stripped area with bare optical fiber 12.

FIG. 4 shows a schematic view of alignment of the optical fiber ribbons 10 for the window stripping process. Optical fiber ribbons 10 are aligned by tensioners 60 from either or both ends to remove the slack in the optical fiber ribbons 10. One or more clamps 62 may hold the ribbon fiber 10 on either side of the stripping area. The clamps 62 are further configured to maintain the desired orientation of the optical fiber ribbon 10. In some embodiments, the clamps 62 may be configured to maintain the window stripping area of the optical fiber ribbon 10 in a relative position to a heating source 112 and the optical fiber ribbon 10 at a predetermined offset from the blades 22.

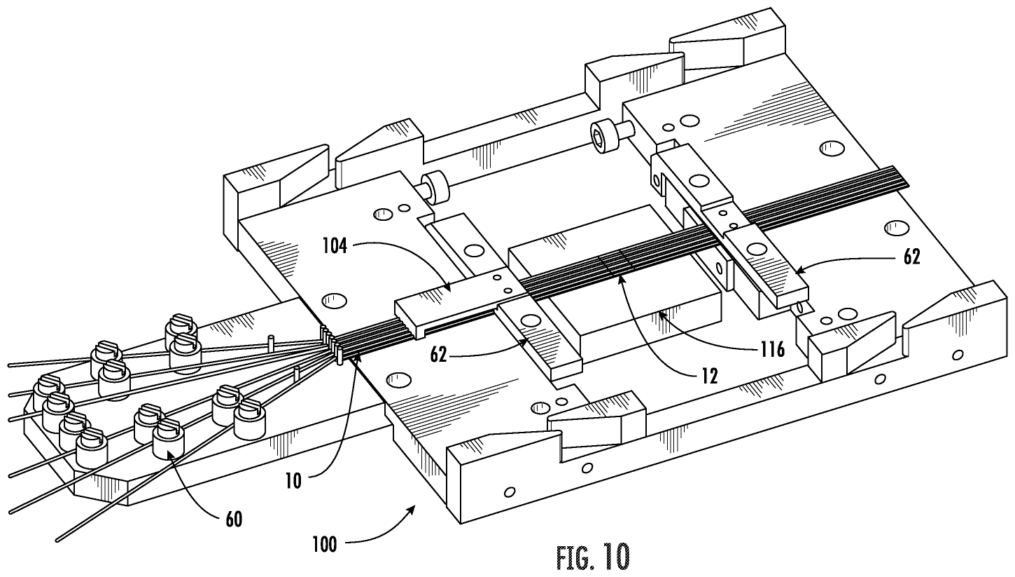

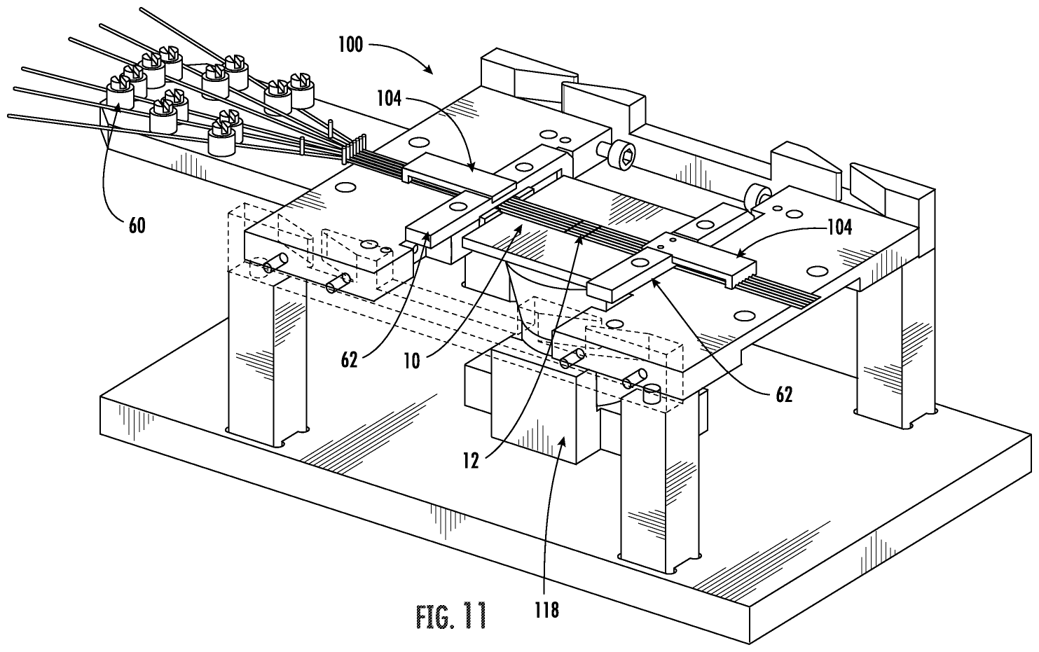

The stripping assembly 106 may be removed from the stripping jig 100 after the window stripping process is completed. Wet cleaning and ultrasonic pre-soldering may be performed while the optical fiber ribbon 10 is mounted in the stripping jig 100. FIG. 10 depicts the optical fiber ribbon 10 including bare optical fiber 12 retained in the stripping jig 100 for wet cleaning. A substrate 116, such as an anodized aluminum substrate, may be positioned beneath the bare optical fiber 12 to provide support for the wet cleaning process described above. FIG. 11 depicts the stripping jig 100 with an ultrasonic pre-soldering assembly 118. The ultrasonic pre-soldering assembly 118 may include a power supply, such as a 110 VAC power supply, a power controller, such as a varistor, a transducer, and a transducer driver. As described above is reference to FIG. 1, the bare optical fibers may be positioned at approximately 1 mm from the ultrasonic transducer 40. Solder 42 may be applied to the bare optical fibers 12 and heated by a heat source 44, such as one or more solder irons, to a temperature above the melting point of 138 degrees Celsius, such as 150-170 degrees Celsius. The solder 42 may be eutectic solder such as Bismuth 58/Tin 42, or non-eutectic solder, such as Bismuth 40/tin 60, or other suitable solder. The ultrasonic pre-soldering may disrupt oxides that form on molten solder and base surfaces during the joining process.

After the stripping, cleaning, and pre-soldering steps are completed, as described above, the clamps 62 may release the optical fiber ribbons 10, which may rotate toward a vertical configuration due to the orientation and tension applied by the tensioners 60.

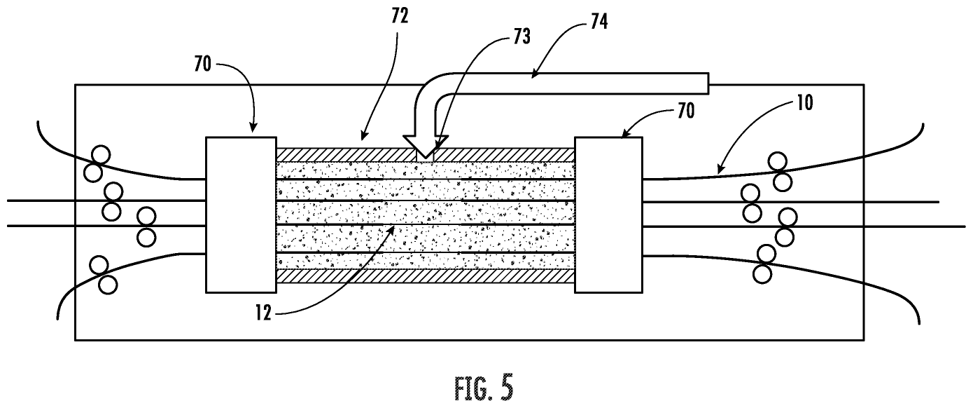

FIG. 5 illustrates an alignment apparatus for hermetic sealing of optical fiber ribbons 10 within a hermetic feed-through tube. The optical fiber ribbons 10 change the position from a planar configuration to a stacked configuration as they transition from the horizontal to vertical configuration. The window stripped area, e.g. the bare optical fiber 12 may be positioned within a hermetic sealing tube 72. The optical fiber ribbons 10 and/or the hermetic sealing tube 72 may be retained in a desired position by sealing blocks 70. The sealing blocks 70 may form a seal at each end of the hermitic sealing tube 72. A pneumatic solder 74 may be injected into the hermetic sealing tube 72 through an injection port 73, and thereby encapsulate the bare optical fiber 12. The apparatus enables the effectiveness operation of stripping, cleaning, pre-wetting and soldering, no single ribbon needs to be aligned again during the processes, avoiding damages to stripped fibers.

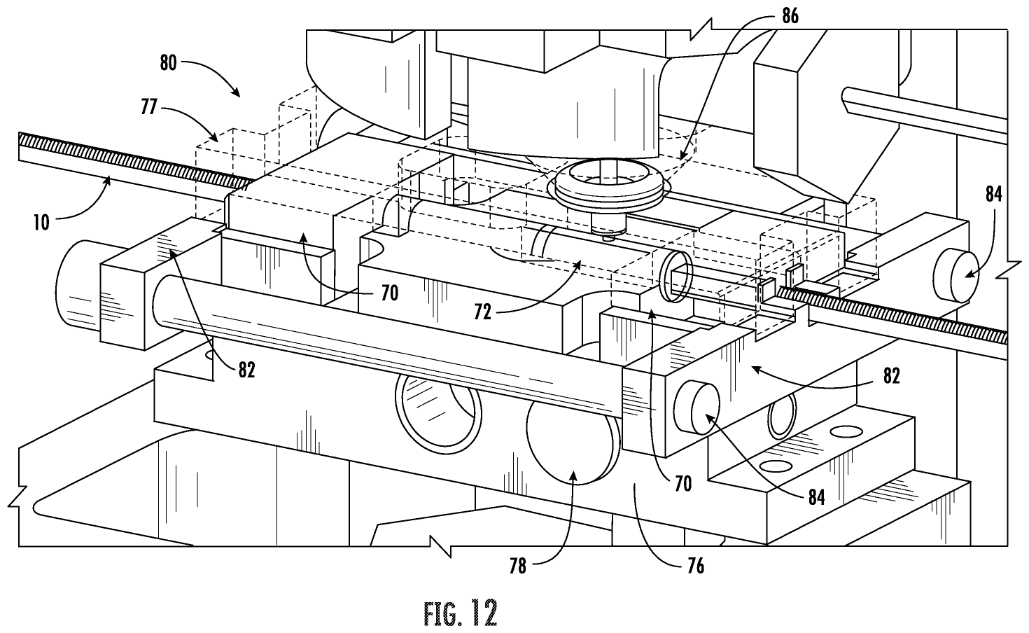

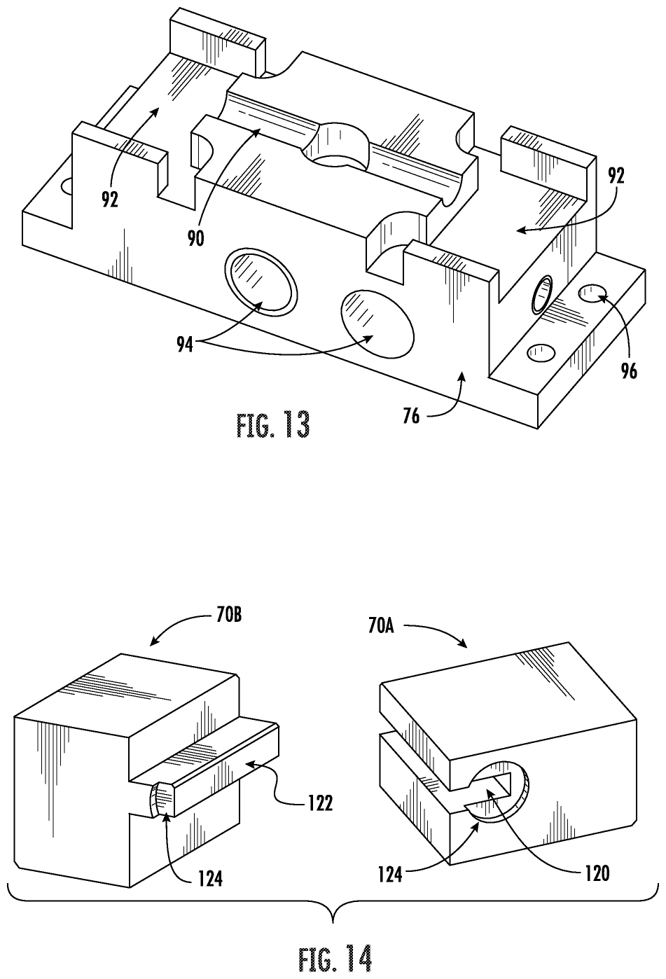

Turning to FIGS. 12-16. The hermetic sealing process is described in further detail. In an example embodiment, a hermetic sealing assembly 80 may be utilized to hermetically seal the optical fiber ribbons 10 in the hermetic sealing tube 72. The hermetic sealing assembly 80 may be used with the stripping jig 100 to maintain alignment of the bare optical fibers 12 throughout the process, or may be utilized separately for the hermetic sealing process steps. FIG. 12 depicts the hermetic sealing assembly 80 according to an example embodiment. The sealing assembly may include a heating block 76, a heating element 78, sealing blocks 70, injection block 77, retention plates 82, and retention fasteners 84. FIG. 13 depicts a heating block 76 according to an example embodiment. The heating block 76 may include one or more mounting features such as fasteners or apertures for fasteners configured to mount the heating block 76 to the stripping jig 100 or other suitable mounting structure. The heating block 76 may include a tube cradle 90 configured to support the hermetic sealing tube 72. The heating block 76 may include one or more sealing block receivers 92. The sealing block receives 92 may be configured to retain the sealing blocks 70 at either or both ends of the tube cradle 90. The heating block 76 may also include one or more heating element receivers 94. The heating element receivers 94 may be configured to receive one or more heating elements, such as a resistive heating element. Further, the heating element receivers 94 may be positioned and configured to distribute heat from the heating element to the tube cradle and ultimately the hermetic sealing tube 72. For example, the heating element and heating block 76 may be configured to heat the hermetic sealing tube 72 to a temperature of approximately 138 degrees Celsius, or other temperature suitable for injection of solder.

FIG. 14 depicts an exploded view of a sealing block 70 according to an example embodiment. The sealing block 70 may include a first portion 70A and a second portion 70B. The first portion 70A may include a fiber channel 120 configured for the optical fiber ribbons 10 to pass through. The fiber channel 120 may be open on one side to enable lateral insertion of the optical fiber ribbons 10 into the fiber channel 120. The second portion 70B may include a complementary or substantially complementary projection 122 configured to seal the opening in the fiber channel 120 when the projection 122 of the second portion 70B is inserted into the opening of the fiber channel 120. The sealing block 70 may also include a recess 124 complementary to the outer diameter of the hermetic sealing tube 72. In an example embodiment, the sealing block portions 70A, 70B may be affixed to each other by a fastener, magnet, or other suitable mechanism.

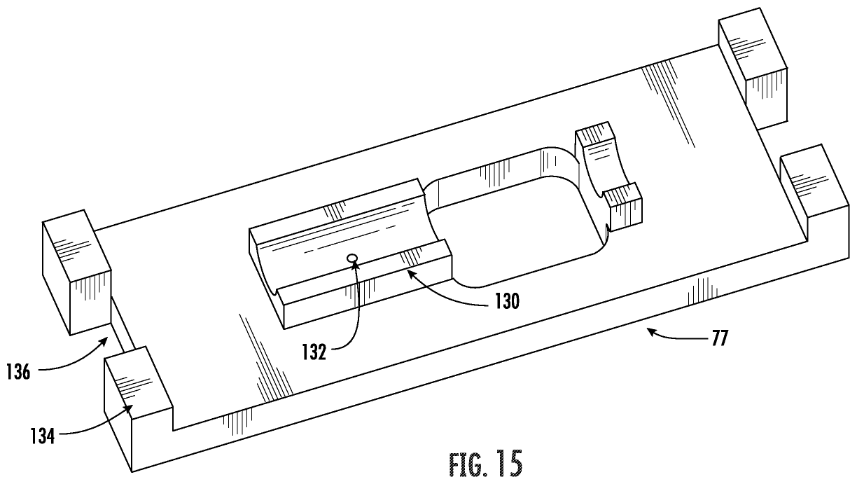

FIG. 15 depicts a bottom perspective view of an injection block 77. The injection block 77 may include a tube cradle 130 configured to rest on the hermetic sealing tube 72. The injection block 77 may include an injection port 132 disposed in the tube cradle 130. The injection port 132 may be disposed such that the injection port 73 of the hermetic sealing tube 72 is aligned with the injection port 132 when the hermetic sealing tube 72 is placed in the tube cradle 90 of the heating block 76, and the injection block 77 is installed on the heating block 76. The injection block 77 may include one or more offset and/or alignment projections 134 configured to offset and or align the injection block 77 relative to the heating block 76, and/or the hermetic sealing tube 72. The projections 134 may include a ribbon guide, or cutout 136 configured to enable the optical fiber ribbon to pass to the sealing blocks 70.

In operation, the heating block 76 is positioned on a support or the stripping jig 100. Next, the optical fiber ribbon is inserted in the fiber channel 120 of a first sealing block 70, which is inserted into a sealing block receiver 92 of the heating block 76. The optical fiber ribbons 10 may be passed through the hermetic sealing tube 72, which may be positioned in the tube cradle 90 of the heating block 76. Once the hermetic sealing tube is placed the optical fiber ribbon 10 may be inserted into the fiber channel 120 of the second sealing block 70, such that the hermetic sealing tube 72 abuts the recess 124 of each sealing block 70. The second sealing block 70 may be positioned in the second sealing block receiver 92 of the heating block 76. The hermetic sealing tube 72 may be rotated to ensure that the injection port 73 is directed in a predetermined orientation, e.g. upward or on top. The injection block 77, may then be installed on the hermetic sealing tube 72 opposite the heating block 76. The injection port 132 of the injection block may be aligned with the injection port 73 of the hermetic sealing tube 72.

Retention plates 82 may be installed on either side of the sealing blocks 70 and tightened using the retention fasteners 84. The retention plates 82 may tighten the sealing blocks 70 to the ends of the hermetic sealing tube 72 to limit or prevent leakage between the hermetic sealing tube 72 and the sealing blocks 70. Additionally, the retention plates 82 may tighten the injection block 77 to the heating block 76 about the hermetic sealing tube 72, which may limit or prevent solder leakage between the hermetic sealing tube 72 and the injection block 77.

Once the hermetic sealing assembly 80 is assembled, the heating element 78 may apply heat to the heating block 76 and hermetic sealing tube 72. The temperature across the hermetic sealing tube 72 may be allowed to equalize to enable consistent solder flow.

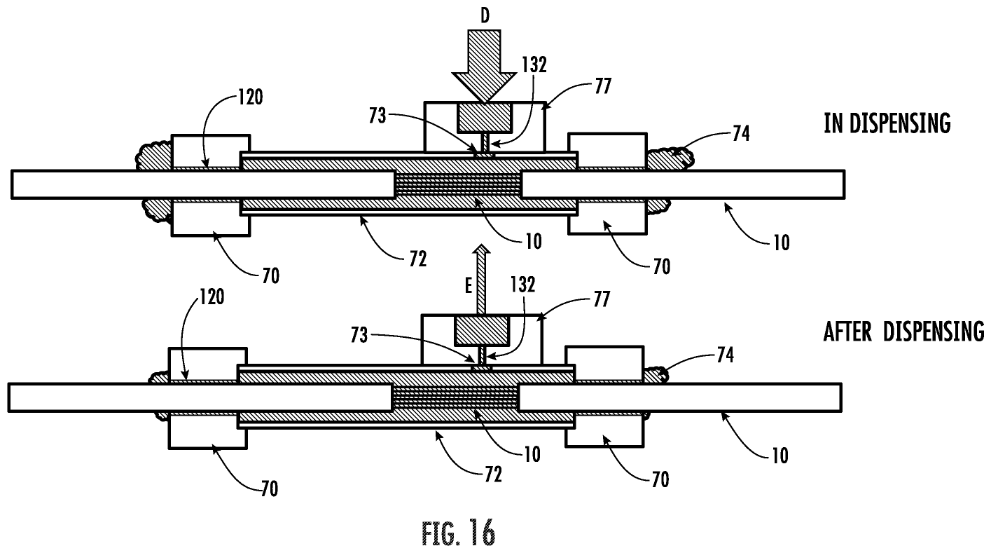

Once temperatures have stabilized, a pressurized solder tank may inject molten solder into the injection port 132 of the injection block 77, as described in further detail below in reference to FIG. 16. The injection block 77 may include a solder port 86 configured to receive and align a solder nozzle 87 with the injection port 132. A sealing ring 88 may be disposed on the solder nozzle 87 and/or the solder port 86 to seal the injection port 132 and to prevent leakage of the solder at the injection port 132.

Turning to FIG. 16, the solder nozzle 87 may inject solder 74 into the solder port 86 and injection port 132 under pressure, for example 6 psi, as depicted by arrow D. The solder 74 may fill the void between the hermetic sealing tube 72 and the optical fiber ribbons 10. The solder 74 may also flow along the optical fiber ribbons in the fiber channel 120, due to over injection, and flow beyond the end of the fiber channel 120. The excess solder may limit or prevent contamination of the hermetic seal along the optical fiber ribbons 10. Over injection of the solder 74 may limit or prevent 1) voids in the solder 74 internal to the hermetic sealing tube 72 and/or 2) anodized alloy remaining in the hermetic sealing tube 72.

Once sufficient over injection has been observed, the pressurized solder tank may be removed from the injection block 77. Removal of the pressure provided by the solder tank may cause the solder 74 to reverse flow, indicated by arrow E, a portion of the excess flow may be pulled back into the fiber channel 120 by the vacuum cause by this solder flow reversal. However, the reversal of solder flow may stop in the fiber channel 120 external to the hermetic sealing tube 72.

The hermetic sealing assembly 80 may be allowed to cool enabling the solder 74 to harden and the assembly to be a suitable temperature to handle. The hermetic sealing assembly 80 may then be disassembled and the optical fiber ribbon 10 including hermetic sealing tube 72 removed.

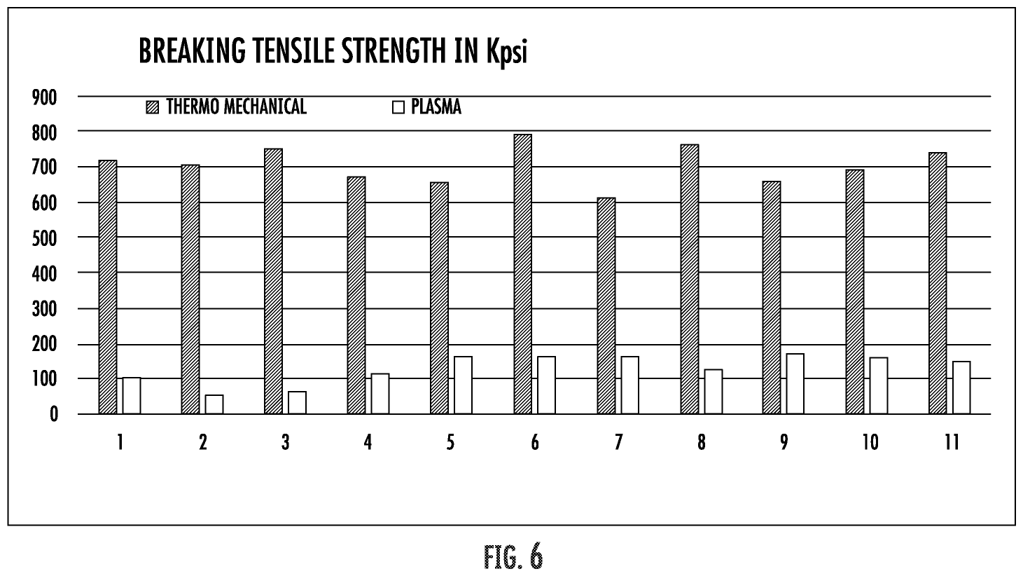

FIG. 6 show the tensile strength test comparisons of single fibers of using the described thermo-mechanical stripping method and hot plasma stripping. The comparison indicates a substantial increase in breaking tensile strength across the samples for the thermo-mechanical stripping over the plasma stripping. The increase in breaking tensile strength of the thermo-mechanically stripped fiber is attributed to damage during the stripping being substantially minimized compared with other stripping methods.

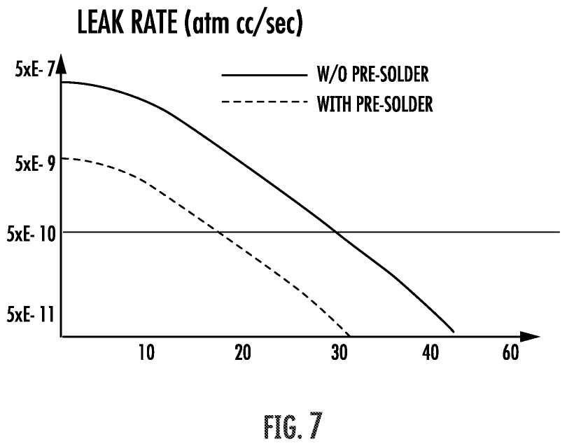

FIG. 7 shows the effectiveness of this thermo-mechanical hematic sealing compared with traditional plasma stripping cerocast method. Eleven sample assemblies were tested the plasma cerocast assemblies had an average breaking tensile strength of approximately 100 Kpsi. The thermo-mechanical hermetic sealing assemblies had an average breaking tensile strength of approximately 700 Kpsi. Advantageously, the thermo-mechanical hermetic sealing assemblies had a breaking tensile strength approximately seven times higher than the plasma cerocast assemblies.

In an example embodiment, a method for window stripping ribbonized optical fibers is provided including applying a tensile force to the ribbonized optical fibers, applying heated air flow to the ribbonized optical fibers, such that a coating of the ribbonized optical fibers softens or detaches from the ribbonized optical fibers, and stripping the coating from a portion of the ribbonized optical fibers using at plurality of blades resulting in a portion of the ribbonized optical fibers comprising bare optical fibers. The plurality of blades do not contact the bare optical fibers.

In some example embodiments, a gap distance between the plurality of blades is larger than a diameter of the bare optical fibers and smaller than a thickness of coating. In an example embodiment, the method also includes positioning the ribbonized optical fibers in a horizontal orientation during stripping the coating from the portion of the ribbonized optical fibers. In some example embodiments, the method also includes wet cleaning of the bare optical fibers to remove residues of the coating. In an example embodiment, the method also includes ultrasonic pre-soldering of the bare optical fibers.

In some example embodiments, the method also includes sealing the bare optical fibers in a tube filled with pressurized solder. In an example embodiment, sealing the bare optical fibers in the tube includes positioning the tube around the bare optical fibers, positioning a sealing block at each end of the tube, such that the ribbonized optical fibers pass through a fiber channel in the sealing block positioned at each end, and injecting a solder through an injection port disposed in a sidewall of the tube, wherein a pressure is applied to the solder. In some example embodiments, sealing the bare optical fibers in the tube includes removing the pressure applied to the solder after the solder issues from the fiber channel in the sealing block positioned at each end. In an example embodiment, sealing the bare optical fibers in the tube includes applying a sealing force to the sealing block at each end of the tube to limit leakage of the solder between the tube and the sealing block at each end of the tube. In some example embodiments, the solder comprises eutectic Bismuth-Tin solder.

In another example embodiment, a stripping jig for window stripping ribbonized optical fibers is provided including a plurality of tensioners configured to apply a tensile force a plurality of ribbonized optical fibers in a parallel vertical orientation, an orientation block configured to apply a rotational force to the plurality of ribbonized optical fibers shifting the plurality of ribbonized optical fibers from the parallel vertical orientation to an approximately 45 degree angle, and at least one clamp configured to restrain the plurality of ribbonized optical fibers and shift the plurality of ribbonized optical fibers to a parallel horizontal orientation in which the plurality of ribbonized optical fibers disposed in a common plane.

In some example embodiments, the stripping jig also includes a plurality of orientation posts configured to vertically align the plurality of ribbonized optical fibers. In an example embodiment, the stripping jig also includes a stripping assembly including a plurality of blades configured to strip a coating from a portion of the plurality of ribbonized optical fibers resulting in a portion of each of the plurality of ribbonized optical fibers comprising bare optical fibers. The plurality of blades do not contact the bare optical fibers. In some example embodiments, the stripping jig also includes a gap control sheet disposed between the plurality of blades, the gap control sheet having a thickness that is greater than the diameter of the plurality of ribbonized optical fibers. In an example embodiment, the stripping assembly also includes an air shroud configured to direct heated air flow toward the plurality of ribbonized optical fibers, such that the coating of the ribbonized optical fibers softens or detaches from the plurality of ribbonized optical fibers. In some example embodiments, the stripping assembly also includes a shuttle configured to translate the plurality of blades longitudinally along a portion of the plurality of ribbonized optical fibers. In an example embodiment, the orientation block is affixed or integral to the at least one clamp. In some example embodiments, the stripping jig also includes an ultrasonic transducer. In an example embodiment, the stripping jig also includes a sealing assembly including a first sealing block and a second sealing block configured to seal each end of a sealing tube. In some example embodiments, the sealing assembly also includes an injection block configured to receive pressurized solder and direct the pressurized solder into an injection port disposed in the sidewall of the sealing tube. In an example embodiment, the first sealing block and the second sealing block each includes a fiber channel disposed therethrough and configured to enable the plurality of ribbonized fibers to pass form a first side to a second side of the sealing block and the sealing block is configured to limit leakage of a solder from between the sealing block and the sealing tube and allow some leakage of the solder through the fiber channel.

Many modifications and other embodiments of the invention set forth herein will come to mind to one skilled in the art to which the invention pertains having the benefit of the teachings presented in the foregoing descriptions and the associated drawings. These modifications include, but are not limited to, number or type of fiber optic modules, use of a fiber optic equipment tray, fiber optic connection type, number of fiber optic adapters, density, etc.

Therefore, it is to be understood that the invention is not to be limited to the specific embodiments disclosed and that modifications and other embodiments are intended to be included within the scope of the appended claims. It is intended that the present invention cover the modifications and variations of this invention provided they come within the scope of the appended claims and their equivalents. Although specific terms are employed herein, they are used in a generic and descriptive sense only and not for purposes of limitation.

What is claimed is:

1. A method for window stripping ribbonized optical fibers comprising:
applying a tensile force to the ribbonized optical fibers;
applying heated air flow to the ribbonized optical fibers, such that a coating of the ribbonized optical fibers softens or detaches from the ribbonized optical fibers; and
stripping the coating from a portion of the ribbonized optical fibers using a plurality of blades resulting in a portion of the ribbonized optical fibers comprising bare optical fibers,
wherein the plurality of blades do not contact the bare optical fibers.

2. The method of claim 1, wherein a gap distance between opposing blades in the plurality of blades is larger than a diameter of the bare optical fibers and smaller than a thickness of coating.

3. The method of claim 1, further comprising:
positioning the ribbonized optical fibers in a horizontal orientation during stripping the coating from the portion of the ribbonized optical fibers.

4. The method of claim 1, further comprising:
wet cleaning of the bare optical fibers to remove residues of the coating.

5. The method of claim 1, further comprising:
ultrasonic pre-soldering of the bare optical fibers.

6. The method of claim 1, further comprising:
sealing the bare optical fibers in a tube filled with pressurized material.

7. The method of claim 6, wherein sealing the bare optical fibers in the tube comprises:
positioning the tube around the bare optical fibers;
positioning respective sealing blocks at each end of the tube, wherein the ribbonized optical fibers pass through a fiber channel in the sealing blocks; and
injecting a solder through an injection port disposed in a sidewall of the tube, wherein a pressure is applied to the solder to form the pressurized material.

8. The method of claim 7, wherein sealing the bare optical fibers in the tube furthers comprises:
removing the pressure applied to the solder after the solder passes through the fiber channel in the sealing blocks positioned at each end.

9. The method of claim 7, wherein sealing the bare optical fibers in the tube furthers comprises:
applying a sealing force to the sealing blocks at each end of the tube to limit leakage of the solder between the tube and the sealing blocks at each end of the tube.

10. The method of claim 1, wherein the pressurized material comprises eutectic Bismuth-Tin solder.

11. A stripping jig for window stripping ribbonized optical fibers, comprising:
a plurality of tensioners configured to apply a tensile force a plurality of ribbonized optical fibers in a parallel vertical orientation;
an orientation block configured to apply a rotational force to the plurality of ribbonized optical fibers for shifting the plurality of ribbonized optical fibers from the parallel vertical orientation to an approximately 45 degree angle; and
at least one clamp configured to restrain the plurality of ribbonized optical fibers and shift the plurality of ribbonized optical fibers to a parallel horizontal orientation in which the plurality of ribbonized optical fibers disposed in a common plane.

12. The stripping jig of claim 11 further comprising:
a plurality of orientation posts configured to vertically orient the plurality of ribbonized optical fibers.

13. The stripping jig of claim 11, further comprising:
a stripping assembly comprising:
a plurality of blades configured to strip a coating from a portion of the plurality of ribbonized optical fibers resulting in a portion of each of the plurality of ribbonized optical fibers comprising bare optical fibers,
wherein the plurality of blades do not contact the bare optical fibers.

14. The stripping jig of claim 13, further comprising:
a gap control sheet disposed between the plurality of blades, the gap control sheet having a thickness that is greater than the diameter of the bare optical fibers.

15. The stripping jig of claim 13, wherein the stripping assembly further comprises:
an air shroud configured to direct heated air flow toward the plurality of ribbonized optical fibers and cause the coating of the ribbonized optical fibers to soften or detach from the plurality of ribbonized optical fibers.

16. The stripping jig of claim 13, wherein the stripping assembly further comprises:
a shuttle configured to translate the plurality of blades longitudinally along a portion of the plurality of ribbonized optical fibers.

17. The stripping jig of claim 11, wherein the orientation block is affixed or integral to the at least one clamp.

18. The stripping jig of claim 11, further comprising an ultrasonic transducer.

19. The stripping jig of claim 11, further comprising:
a sealing assembly comprising:
a first sealing block and a second sealing block configured to seal each end of a sealing tube.

20. The stripping assembly of claim 19, wherein the sealing assembly further comprises an injection block configured to receive pressurized solder and direct the pressurized solder into an injection port disposed in the sidewall of the sealing tube.
